(19) United States
(12) Patent Application Publication
(10) Pub. No.: US 2026/0147132 A1
(43) Pub. Date: May 28, 2026

(54) WELL - SEISMIC ANALYSIS SYSTEM AND METHOD BASED ON TIGHT SANDSTONE GEOLOGICAL - MECHANICAL COUPLED LITHOFACIES SYSTEM, AND DEVICE

(71) Applicants: Southwest Petroleum University, Chengdu City, (CN); Chengdu University of Technology, Chengdu City, (CN)

(72) Inventors: Chenghua OU, Chengdu City, (CN); Zeyu WANG, Chengdu City, (CN); Haiyan ZHU, Chengdu City, (CN); Chaochun LI, Chengdu City, (CN)

(21) Appl. No.: 19/049,486

(22) Filed: Feb. 10, 2025

(30) Foreign Application Priority Data
Nov. 27, 2024 (CN) 202411713195.4

(51) Int. Cl. G01V 1/50; E21B 49/00

(52) U.S. Cl. CPC G01V 1/50; E21B 49/00; G01V 2210/66

(57) ABSTRACT

Provided are a well-seismic analysis system and method based on a tight sandstone geological-mechanical coupled lithofacies system, and a device. The system includes a classification mode construction module configured to construct a geological-mechanical coupled lithofacies classification mode for a tight sandstone reservoir based on the information data through a four-element composite triangle chart method. An integration module classifies geological-mechanical coupled lithofacies at a single-well level based on element difference data and integrate multi-type lithofacies prediction results. An analysis and determination module performs, by a well-seismic collaborative three-dimensional model of the geological-mechanical coupled lithofacies in the tight sandstone reservoir, characteristic extraction of the geological-mechanical coupled lithofacies, lithofacies classification feedback adjustment, and seismic attribute mapping, and determines geological-mechanical coupled lithofacies distribution information data of the tight sandstone reservoir.

### CROSS REFERENCE TO RELATED APPLICATION

This patent application claims the benefit and priority of Chinese Patent Application No. 202411713195.4, filed with the China National Intellectual Property Administration on Nov. 27, 2024, the disclosure of which is incorporated by reference herein in its entirety as part of the present application.

### TECHNICAL FIELD

The present disclosure relates to the field of tight sandstone oil and gas extraction analysis, and in particular to a well-seismic analysis system and method based on a tight sandstone geological-mechanical coupled lithofacies system, and a device.

### BACKGROUND

Tight sandstone reservoirs have enormous oil and gas resource potential and considerable scale reserves. To acquire oil and gas resources enriched in tight sandstone reservoirs, it is necessary to search for geological sweet spots based on traditional geological lithofacies and engineering sweet spots based on geological and mechanical characteristics, so as to guide drilling and artificial transformation of tight sandstone oil and gas reservoirs. Ultra-long horizontal wells and large-scale refracturing are essential means for the current development of tight sandstone oil and gas. Since ultra-long horizontal wells and large-scale refracturing are essentially mechanical behaviors, process parameters can only be optimized based on accurate rock mechanics and geostress parameter fields, thereby improving drilling and fracturing efficiency. However, the existing modeling of rock mechanics and geostress parameter fields is performed through deterministic or stochastic interpolation methods, resulting in significant differences between modeling results and the geological and mechanical characteristics of the tight sandstone reservoir, making it fail to effectively guide ultra-long horizontal wells and large-scale refracturing.

Essentially, the rock mass of tight sandstone in the reservoir is deeply buried underground and is a unity of geological and mechanical characteristics. The construction of a lithofacies system to accurately characterize the rock mass of tight sandstone that unifies geological and mechanical characteristics is a global challenge that has not yet been solved.

### SUMMARY

An objective of the present disclosure is to provide a well-seismic analysis system and method based on a tight sandstone geological-mechanical coupled lithofacies system, and a device. The present disclosure can determine the heterogeneous distribution law of rock mechanics and geostress characteristics of the tight sandstone reservoir, providing a basis for improving the oil and gas extraction effect of the tight sandstone reservoir.

To achieve the above objective, the present disclosure provides the following technical solutions.

A first aspect of the present disclosure provides well-seismic analysis system based on a tight sandstone geological-mechanical coupled lithofacies system, including an information data acquisition module configured to acquire information data, including characteristic core data and rock mechanics data, where the characteristic core data includes characteristic data acquired through a three-dimensional nine-point method and parameter data determined based on a mechanical experiment. The rock mechanics data is parameter data that is sensitive to rock mechanics performance of different lithofacies and is acquired by setting different lithofacies numerical experiments based on a theory of lithofacies discretization and sensitivity analysis to study an influence of a lithofacies change on a rock strength and a fracture propagation behavior.

A classification mode construction module is connected to the information data acquisition module, and is configured to construct a geological-mechanical coupled lithofacies classification mode for a tight sandstone reservoir based on the information data through a four-element composite triangle chart method.

An integration module is connected to the classification mode construction module, and is configured to classify, by the geological-mechanical coupled lithofacies classification mode of the tight sandstone reservoir, geological-mechanical coupled lithofacies at a single-well level based on element difference data, and integrate multi-type lithofacies prediction results to acquire an integration result, where the element difference data includes particle composition, particle size, brittleness index, and horizontal stress difference.

An analysis and determination module is connected to the integration module, and is configured to perform, by a well-seismic collaborative three-dimensional model of the geological-mechanical coupled lithofacies in the tight sandstone reservoir, characteristic extraction of the geological-mechanical coupled lithofacies, lithofacies classification feedback adjustment, and seismic attribute mapping based on the integration result, and determine geological-mechanical coupled lithofacies distribution information data of the tight sandstone reservoir, where the well-seismic collaborative three-dimensional model of the geological-mechanical coupled lithofacies in the tight sandstone reservoir is a physical model constructed based on seismic data and a geological-mechanical characteristic relationship. The geological-mechanical coupled lithofacies distribution information data of the tight sandstone reservoir is configured to characterize a heterogeneous distribution law of a rock mechanics and geostress characteristic of the tight sandstone reservoir, providing a basis for improving an effect of tight sandstone oil and gas extraction.

A second aspect of the present disclosure provides well-seismic analysis method based on a tight sandstone geological-mechanical coupled lithofacies system, implemented through the above-mentioned system, and including acquiring information data, including characteristic core data and rock mechanics data, where the characteristic core data includes characteristic data acquired through a three-dimensional nine-point method and parameter data determined based on a mechanical experiment; and the rock mechanics data is parameter data that is sensitive to rock mechanics performance of different lithofacies and is acquired by setting different lithofacies numerical experiments based on a theory of lithofacies discretization and sensitivity analysis to study an influence of a lithofacies change on a rock strength and a fracture propagation behavior.

A geological-mechanical coupled lithofacies classification mode for a tight sandstone reservoir is constructed based on the information data through a four-element composite triangle chart method.

Geological-mechanical coupled lithofacies at a single-well level are classified by the geological-mechanical coupled lithofacies classification mode of the tight sandstone reservoir based on element difference data, and integrating multi-type lithofacies prediction results to acquire an integration result, where the element difference data includes particle composition, particle size, brittleness index, and horizontal stress difference.

Characteristic extraction of the geological-mechanical coupled lithofacies, lithofacies classification feedback adjustment, and seismic attribute mapping based on the integration result is performed by a well-seismic collaborative three-dimensional model of the geological-mechanical coupled lithofacies in the tight sandstone reservoir, and geological-mechanical coupled lithofacies distribution information data of the tight sandstone reservoir is determined, where the well-seismic collaborative three-dimensional model of the geological-mechanical coupled lithofacies in the tight sandstone reservoir is a physical model constructed based on seismic data and a geological-mechanical characteristic relationship, and the geological-mechanical coupled lithofacies distribution information data of the tight sandstone reservoir is configured to characterize a heterogeneous distribution law of a rock mechanics and geostress characteristic of the tight sandstone reservoir, providing a basis for improving an effect of tight sandstone oil and gas extraction.

A third aspect of the present disclosure provide a computer device, including a memory, a processor, and a computer program stored in the memory and executable in the processor, where the processor is configured to execute the computer program so as to implement the above-mentioned well-seismic analysis method based on a tight sandstone geological-mechanical coupled lithofacies system.

According to specific embodiments provided by the present disclosure, the present has the following technical effects:

The present disclosure provides a well-seismic analysis system and method based on a tight sandstone geological-mechanical coupled lithofacies system, and a device. The present disclosure determines the factors that affect the horizontal drilling and artificial transformation potential of the tight sandstone reservoir based on the rock mechanics characteristics and transformation potential of the tight sandstone reservoir. The present disclosure constructs a classification model for the geological-mechanical coupled lithofacies in the tight sandstone reservoir, achieving single-well quantitative identification and prediction of the geological-mechanical coupled lithofacies in the tight sandstone reservoir, and characterizing the heterogeneous distribution characteristics of the geological-mechanical coupled lithofacies in the tight sandstone reservoir. The present disclosure provides technical support for facies control heterogeneity modeling of rock mechanics and geostress in the tight sandstone reservoir to effectively implement ultra-long horizontal wells+large-scale refracturing, thereby ultimately achieving efficient tight sandstone oil and gas extraction. Therefore, the present disclosure can determine the heterogeneous distribution law of rock mechanics and geostress characteristics of the tight sandstone reservoir, providing a basis for improving the effect of tight sandstone oil and gas extraction.

### BRIEF DESCRIPTION OF THE DRAWINGS

FIG. 1 is a schematic diagram of a lithology classification isosceles-triangle chart of a tight sandstone reservoir;

FIG. 2 is a structural diagram of a well-seismic analysis system based on a tight sandstone geological-mechanical coupled lithofacies system;

FIG. 3 is a flowchart of a well-seismic analysis solution based on a tight sandstone geological-mechanical coupled lithofacies system;

FIG. 4 is a schematic diagram of sampling a tight sandstone reservoir by a three-dimensional nine-point method;

FIG. 5 is a schematic diagram of sampling points in a case area of a tight sandstone reservoir in a production area by a three-dimensional nine-point method;

FIG. 6 is a cross plot of elastic modulus and Poisson's ratio;

FIG. 7 is a cross plot of a fracture length and fracture density with a horizontal stress difference;

FIG. 8 is a composite isosceles-triangle chart mode for the classification of geological-mechanical coupled lithofacies in a tight sandstone reservoir;

FIG. 9 is a schematic diagram of a classification result for the geological-mechanical coupled lithofacies of the tight sandstone reservoir;

FIG. 10 is a comprehensive column chart of a quantitative identification result of a geological-mechanical coupled lithofacies in a tight sandstone gas well; where A1: Depth, A2: Stratum, A3: Lithology, A4: Quartz content, A5: Lithic content, A6: Feldspar content, A7: Porosity %, A8: Permeability mD, A9: Horizontal stress difference MPa, A10: Brittleness index, A11: Natural gamma API, A12: Density g/cm³, A13: Elastic modulus GPa, A14: Poisson's ratio, A15: Geological-mechanical coupled lithofacies, A16: Shiqianfeng Formation, A17: Low-stress-difference tough quartz medium sandstone, A18: Mudstone, A19: Low-stress-difference low-brittleness lithic feldspar fine sandstone, A20: Mudstone, A21: Low-stress-difference low-brittleness feldspar lithic fine sandstone, A22: Mudstone, A23: Low-stress-difference tough lithic feldspar siltstone, A4: Mudstone, A25: Low-stress-difference low-brittleness quartz coarse sandstone, A26: Mudstone, A27: Low-stress-difference tough quartz fine sandstone;

FIG. 11 is a longitudinal impedance inversion profile of the geological-mechanical coupled lithofacies in the tight sandstone reservoir;

FIG. 12 is a schematic diagram of a three-dimensional model of the geological-mechanical coupled lithofacies in the tight sandstone reservoir;

FIG. 13 is a first distribution diagram of the geological-mechanical coupled lithofacies in the tight sandstone reservoir;

FIG. 14 is a second distribution diagram of the geological-mechanical coupled lithofacies in the tight sandstone reservoir;

FIG. 15 is a column scatter plot of productivity distribution of the tight sandstone reservoir;

FIG. 16 is a schematic diagram of a brittleness index model of the tight sandstone reservoir;

FIG. 17 is a column chart of facies control rock mechanics of a control well in the tight sandstone reservoir; where B1: Depth, B2: Lithology, B3: Elastic modulus MPa (facies control), B4: Poisson's ratio (facies control), B5: Brittleness index (facies control), B6: Maximum horizontal principal stress MPa (facies control), B7: Minimum horizontal principal stress MPa (facies control), B8: Horizontal stress difference MPa (facies control), B9: Elastic modulus MPa (interpolation), B10: Poisson's ratio (interpolation), B11: Brittleness index (interpolation), B12: Maximum horizontal principal stress MPa (interpolation), B13: Minimum horizontal principal stress MPa (interpolation), B14: Horizontal stress difference MPa (interpolation), B15: Geological-mechanical coupled lithofacies, B16: Low-stress-difference low-brittleness feldspar lithic siltstone, B17: Silty mudstone, B18: Mudstone, B19: Low-stress-difference low-brittleness feldspar lithic siltstone, B20: Mudstone, B21: Silty mudstone, B22: Low-stress-difference tough lithic feldspar siltstone, B23: Mudstone, B24: Low-stress-difference high-brittleness quartz fine sandstone, B25: Mudstone, B26: Silty mudstone; and

FIG. 18 is a structural diagram of a computer device.

### DETAILED DESCRIPTION OF THE EMBODIMENTS

Currently, many scholars have conducted research on the major tight sandstone reservoirs in the world. Nuclear magnetic resonance (NMR) logging and acoustic time difference logging are combined to jointly calculate the porosity of low-permeability gas reservoirs, and the combination is applied in practical production to improve the calculation accuracy. The method of directly identifying tight sandstone gas reservoirs and the quantitative identification method can improve the traditional Stacking model, and can better learn the complex characteristics and variation laws of different reservoir types. A “double sweet spot” reservoir prediction method for tight sandstone reservoirs integrates geological sweet spots with engineering sweet spots, and can objectively evaluate the production potential of low-permeability reservoirs. Based on a comprehensive study of sedimentary microfacies, pore structure, and diagenesis of the reservoir, the main controlling factors for the development of the tight sandstone reservoir are explained.

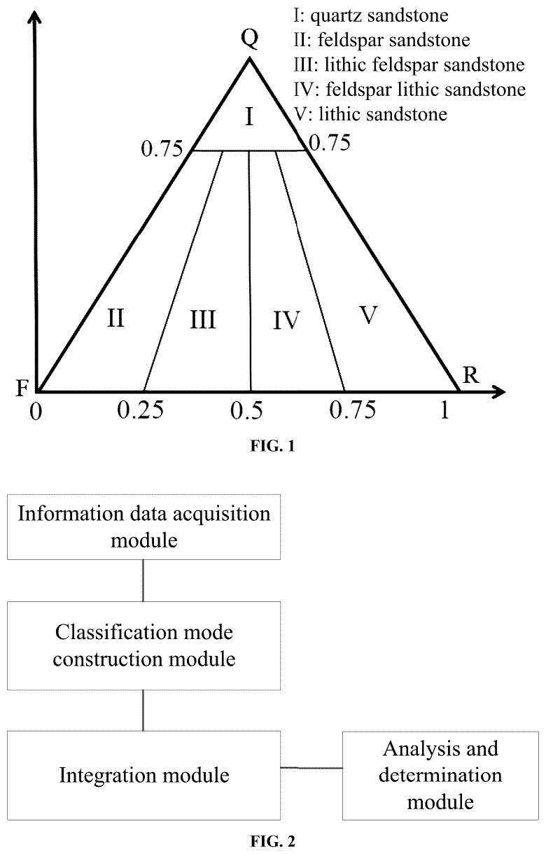

At present, the classification method for tight sandstone reservoirs is to select the main minerals of the tight sandstone reservoir, namely quartz (Q), feldspar (F), and lithic fragment (R), to form a mineral content triangle (FIG. 1). According to quartz content (q), feldspar content (f), and lithic content (r), four auxiliary lines of q=0.75, r/(f+r)=0.25 r/(f+r)=0.5, and r/(f+r)=0.75 are formed, corresponding to q=0.75, r/f=1:3, r/f=1:1, and r/f=3:1. Regarding value readings in a facies map, X=r+q/2, Y=q.

Different minerals undergo different hydration reactions during diagenesis. Rocks with clay minerals will expand and contract after absorbing water, thereby affecting the pore structure, permeability, and productivity of the reservoir. During the flow process of oil and gas fluids, the different mineral components of the reservoir interact with each other, affecting the distribution and preferential flow path of oil and gas. High-strength sandstone may be more stable under high pressure conditions, helping to maintain the structure and vertical connectivity of the reservoir, thereby increasing oil and gas production capacity.

Sedimentary rocks of different particle sizes (such as sandstone and mudstone) have a significant impact on the characteristics of oil and gas reservoirs. An increase in fluid resistance may lead to poor flow of small-sized rocks, thereby affecting mining efficiency and productivity. Large-sized particles often make the rock structure more stable, thereby reducing engineering risks, and ensuring the normal operation of drilling and production equipment and the sustainability of production capacity.

In the comprehensive study of geology-mechanics, due to different sedimentary environments, burial depths, and petrological characteristics, the rock mechanics and geostress characteristics of different lithofacies show significant differences. The characterization and modeling of geological-mechanical coupled lithofacies usually consider the geological characteristics and mechanical properties of rocks. The constructed lithofacies model couples geological lithofacies and mechanical properties, and can be used to analyze the mechanical characteristics of each lithofacies and accurately predict the deformation, failure, and stability of rocks.

The current research results mainly focus on the specific study of the mechanical properties of different lithofacies. In rock mechanics research and three-dimensional modeling, the analysis is relatively independent, and the constraints of rock mechanics parameters are relatively vague. The modeling results acquired are significantly different from the geological and mechanical characteristics of the tight sandstone reservoir, and there is no further subdivision of the coupled mechanical properties of geological lithofacies. Therefore, there is a certain limitation on further construction of a geological-mechanical coupled lithofacies classification solution.

For tight sandstone reservoirs, the current modeling of rock mechanics and geostress parameter fields is performed through deterministic or stochastic interpolation methods. The modeling results obtained differ greatly from the geological and mechanical characteristics of the tight sandstone reservoir, and cannot effectively guide ultra-long horizontal wells+large-scale refracturing, which restricts the further production efficiency of the tight sandstone reservoir.

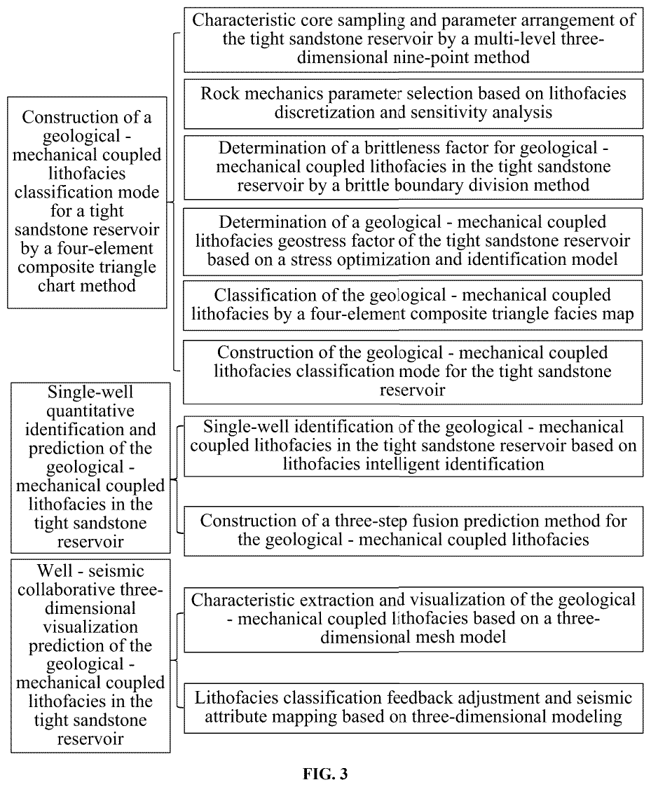

As shown in FIG. 2, the present disclosure provides well-seismic analysis system based on a tight sandstone geological-mechanical coupled lithofacies system, including: an information data acquisition module, a classification mode construction module, an integration module, and an analysis and determination module.

The information data acquisition module is configured to acquire information data, including characteristic core data and rock mechanics data, where the characteristic core data includes characteristic data acquired through a three-dimensional nine-point method and parameter data determined based on a mechanical experiment; and the rock mechanics data is parameter data that is sensitive to rock mechanics performance of different lithofacies and is acquired by setting different lithofacies numerical experiments based on a theory of lithofacies discretization and sensitivity analysis to study an influence of a lithofacies change on a rock strength and a fracture propagation behavior.

The classification mode construction module is connected to the information data acquisition module, and configured to construct a geological-mechanical coupled lithofacies classification mode for a tight sandstone reservoir based on the information data through a four-element composite triangle chart method.

The integration module is connected to the classification mode construction module, and configured to classify, by the geological-mechanical coupled lithofacies classification mode of the tight sandstone reservoir, geological-mechanical coupled lithofacies at a single-well level based on element difference data, and integrate multi-type lithofacies prediction results to acquire an integration result, where the element difference data includes particle composition, particle size, brittleness index, and horizontal stress difference.

The analysis and determination module is connected to the integration module, and configured to perform, by a well-seismic collaborative three-dimensional model of the geological-mechanical coupled lithofacies in the tight sandstone reservoir, characteristic extraction of the geological-mechanical coupled lithofacies, lithofacies classification feedback adjustment, and seismic attribute mapping based on the integration result, and determine geological-mechanical coupled lithofacies distribution information data of the tight sandstone reservoir, where the well-seismic collaborative three-dimensional model of the geological-mechanical coupled lithofacies in the tight sandstone reservoir is a physical model constructed based on seismic data and a geological-mechanical characteristic relationship; and the geological-mechanical coupled lithofacies distribution information data of the tight sandstone reservoir is configured to characterize a heterogeneous distribution law of a rock mechanics and geostress characteristic of the tight sandstone reservoir, providing a basis for improving an effect of tight sandstone oil and gas extraction.

The classification mode construction module includes: a brittleness factor determination sub-module, a geostress factor determination sub-module, a chart determination sub-module, and a classification mode construction sub-module.

The brittleness factor determination sub-module is connected to the information data acquisition module, and configured to visualize a relationship between an elastic modulus and a Poisson's ratio based on information data through a brittle boundary division method and divide a material property by a negative slope line to determine a brittleness factor for the geological-mechanical coupled lithofacies in the tight sandstone reservoir.

The geostress factor determination sub-module is connected to the information data acquisition module, and configured to determine, by a stress optimization and identification model, a geostress factor for the geological-mechanical coupled lithofacies in the tight sandstone reservoir based on the information data, where the stress optimization and identification model is a physical model about an influence of a horizontal stress difference on fracture propagation in the tight sandstone reservoir and is constructed based on the horizontal stress difference that influences fracture formation, propagation, and connection in a horizontal multi-stage fracturing operation.

The chart determination sub-module is connected to the brittleness factor determination sub-module and the geostress factor determination sub-module separately, and configured to integrate, by a lithology classification isosceles-triangle chart of the tight sandstone reservoir, the particle size, horizontal stress difference, and brittleness index for composite triangle chart mode processing based on the brittleness factor and the geostress factor of the geological-mechanical coupled lithofacies in the tight sandstone reservoir, thereby acquiring a composite isosceles-triangle chart for the classification of the geological-mechanical coupled lithofacies in the tight sandstone reservoir.

The classification mode construction sub-module is connected to the chart determination sub-module, and configured to name, by the composite isosceles-triangle chart for the classification of the geological-mechanical coupled lithofacies in the tight sandstone reservoir, types of the geological-mechanical coupled lithofacies by taking the particle composition and particle size as a name part and the horizontal stress difference and brittleness index as a modificatory prefix, thereby determining the geological-mechanical coupled lithofacies classification mode of the tight sandstone reservoir.

The integration module includes: a single-well identification result acquisition sub-module, a classification sub-module, and an integration processing sub-module.

The single-well identification result acquisition sub-module is configured to acquire a single-well identification result of a geological lithofacies in the tight sandstone reservoir.

The classification sub-module is connected to the single-well identification result acquisition sub-module and the classification mode construction module separately, and configured to classify, based on the geological-mechanical coupled lithofacies classification mode of the tight sandstone reservoir and the single-well identification result of the geological lithofacies in the tight sandstone reservoir, the geological-mechanical coupled lithofacies at the single-well level according to the element difference data, and acquire a classification result.

The integration processing sub-module is connected to the classification sub-module, and configured to perform numerical mapping, priority selection, and classification processing based on the classification result and integrate multi-type lithofacies prediction results to acquire the integration result.

The present disclosure further provides a well-seismic analysis method based on a tight sandstone geological-mechanical coupled lithofacies system, implemented through the above-mentioned system, and includes the following steps.

Information data are acquired, including characteristic core data and rock mechanics data, where the characteristic core data includes characteristic data acquired through a three-dimensional nine-point method and parameter data determined based on a mechanical experiment. The rock mechanics data is parameter data that is sensitive to rock mechanics performance of different lithofacies and is acquired by setting different lithofacies numerical experiments based on a theory of lithofacies discretization and sensitivity analysis to study an influence of a lithofacies change on a rock strength and a fracture propagation behavior.

The characteristic data includes lithology, particle type, and particle size. The parameter data includes: clastic modulus, Poisson's ratio, brittleness, cohesion, fracture toughness, fracture pressure, internal friction angle, tensile strength, shear strength, maximum horizontal principal stress, minimum horizontal principal stress, vertical stress, and horizontal stress difference.

A geological-mechanical coupled lithofacies classification mode for a tight sandstone reservoir is constructed based on the information data through a four-element composite triangle chart method.

The geological-mechanical coupled lithofacies are classified by the geological-mechanical coupled lithofacies classification mode of the tight sandstone reservoir at a single-well level based on element difference data, and multi-type lithofacies prediction results are integrated to acquire an integration result. The element difference data includes particle composition, particle size, brittleness index, and horizontal stress difference.

Characteristic extraction of the geological-mechanical coupled lithofacies, lithofacies classification feedback adjustment, and seismic attribute mapping are performed by a well-seismic collaborative three-dimensional model of the geological-mechanical coupled lithofacies in the tight sandstone reservoir based on the integration result. Geological-mechanical coupled lithofacies distribution information data of the tight sandstone reservoir are determined. The well-seismic collaborative three-dimensional model of the geological-mechanical coupled lithofacies in the tight sandstone reservoir is a physical model constructed based on seismic data and a geological-mechanical characteristic relationship. The geological-mechanical coupled lithofacies distribution information data of the tight sandstone reservoir is configured to characterize a heterogeneous distribution law of a rock mechanics and geostress characteristic of the tight sandstone reservoir, providing a basis for improving an effect of tight sandstone oil and gas extraction.

In an embodiment, the geological-mechanical coupled lithofacies classification mode of the tight sandstone reservoir is constructed based on the information data through a four-element composite triangle chart method. The specific step is as follows.

Based on information data, a relationship between an elastic modulus and a Poisson's ratio is visualized through a brittle boundary division method, and a material property is divided by a negative slope line to determine a brittleness factor for the geological-mechanical coupled lithofacies in the tight sandstone reservoir.

A geostress factor for the geological-mechanical coupled lithofacies in the tight sandstone reservoir is determined by a stress optimization and identification model based on the information data. The stress optimization and identification model is a physical model about an influence of a horizontal stress difference on fracture propagation in the tight sandstone reservoir and is constructed based on the horizontal stress difference that influences fracture formation, propagation, and connection in a horizontal multi-stage fracturing operation.

Based on a lithology classification isosceles-triangle chart of the tight sandstone reservoir, the particle size, the horizontal stress difference, and the brittleness index are integrated for composite triangle chart mode processing according to a brittleness factor and a geostress factor for the geological-mechanical coupled lithofacies in the tight sandstone reservoir, thereby acquiring a composite isosceles-triangle chart for the classification of the geological-mechanical coupled lithofacies in the tight sandstone reservoir.

Based on the composite isosceles-triangle chart for the classification of the geological-mechanical coupled lithofacies in the tight sandstone reservoir, types of the geological-mechanical coupled lithofacies are named by taking the particle composition and particle size as a name part and the horizontal stress difference and brittleness index as a modificatory prefix, thereby determining the geological-mechanical coupled lithofacies classification mode of the tight sandstone reservoir.

Geological-mechanical coupled lithofacies classification is performed by the geological-mechanical coupled lithofacies classification mode of the tight sandstone reservoir at a single-well level based on element difference data, and multi-type lithofacies prediction results are integrated to acquire an integration result. The specific step is as follows.

A single-well identification result of a geological lithofacies in the tight sandstone reservoir is acquired. Based on the geological-mechanical coupled lithofacies classification mode of the tight sandstone reservoir and the single-well identification result of the geological lithofacies in the tight sandstone reservoir, the geological-mechanical coupled lithofacies are classified at the single-well level according to the element difference data, and a classification result is acquired. Numerical mapping, priority selection, and classification processing are performed based on the classification result and integrate multi-type lithofacies prediction results to acquire the integration result.

The well-seismic collaborative three-dimensional model of the geological-mechanical coupled lithofacies in the tight sandstone reservoir is specifically determined as follows.

Raw data are acquired, where the raw data are data including geological, seismic, and mechanical properties; and the raw data includes geological profile, lithological data, seismic wave velocity, porosity, and permeability. The raw data are preprocessed to acquire processed data, where the preprocessing includes interpolation, denoising, and normalization. A three-dimensional mesh model is constructed, where the three-dimensional network model is a physical model constructed based on a spatial distribution and characteristic of a geological body to characterize a geological-mechanical characteristic relationship.

Characteristic extraction is performed on the geological-mechanical coupled lithofacies based on the processed data to acquire extracted data. Sensitive attribute analysis is performed on the geological-mechanical coupled lithofacies based on geological attribute data and the extracted data to acquire analyzed data.

Inversion is performed by the three-dimensional mesh model based on the analyzed data, and inversion information data are determined, including seismic wave velocity and impedance. The inversion information data is compared with an actual underground sampling result, and an inversion parameter of the three-dimensional mesh model is trained and adjusted with a goal of minimizing an error of a comparison result, thereby acquiring an adjusted three-dimensional mesh model.

The adjusted three-dimensional mesh model is determined as the well-seismic collaborative three-dimensional model of the geological-mechanical coupled lithofacies in the tight sandstone reservoir.

As shown in FIG. 3, the core of the technical solution of the present disclosure lies in the construction of a geological-mechanical coupled lithofacies classification mode for a tight sandstone reservoir by a four-element composite triangle chart method. The construction includes six key tasks: characteristic core sampling and parameter arrangement of the tight sandstone reservoir by a multi-level three-dimensional nine-point method, rock mechanics parameter selection based on lithofacies discretization and sensitivity analysis, determination of a brittleness factor for geological-mechanical coupled lithofacies in the tight sandstone reservoir by a brittle boundary division method, determination of a geological-mechanical coupled lithofacies geostress factor of the tight sandstone reservoir based on a stress optimization and identification model, classification of the geological-mechanical coupled lithofacies by a four-element composite triangle facies map, and construction of the geological-mechanical coupled lithofacies classification mode for the tight sandstone reservoir. On this basis, single-well quantitative identification and prediction of the geological-mechanical coupled lithofacies in the tight sandstone reservoir is performed, including two tasks: single-well identification of the geological-mechanical coupled lithofacies in the tight sandstone reservoir based on lithofacies intelligent identification and construction of a three-step fusion prediction method for the geological-mechanical coupled lithofacies. Finally, well-seismic collaborative three-dimensional visualization characterization of the geological-mechanical coupled lithofacies in the tight sandstone reservoir is performed, which includes two tasks: characteristic extraction and visualization of the geological-mechanical coupled lithofacies based on a three-dimensional mesh model and lithofacies classification feedback adjustment and seismic attribute mapping based on three-dimensional modeling.

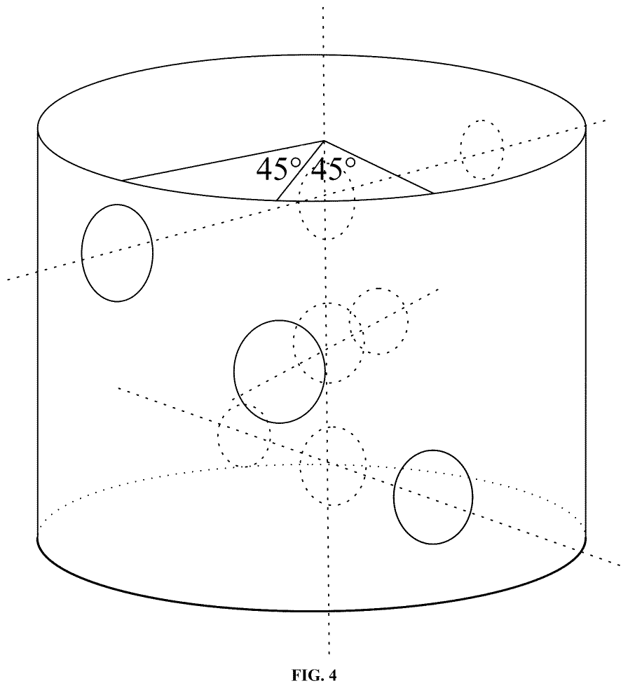

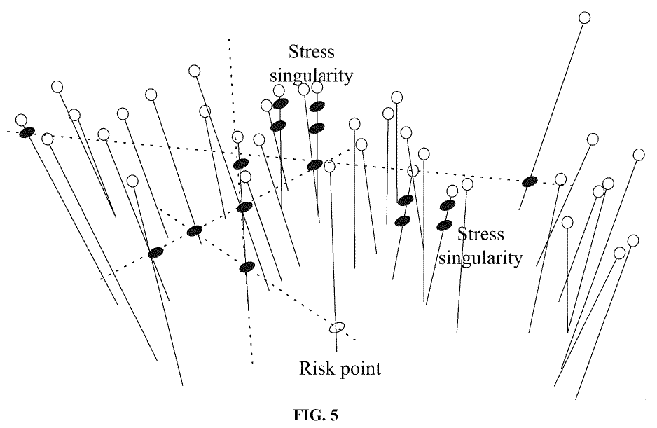

It is crucial to select representative sample points in the study of tight sandstone reservoirs, as these samples will directly affect the understanding of geological and mechanical characteristics and the construction of models. Firstly, based on the three-dimensional nine-point method shown in FIG. 4, a core sample is taken at a 45-degree angle. This can minimize the damage to the original structure of the rock during the sampling process. Oblique sampling can reduce stress concentration during core taking, minimize the possibility of fractures or fractures during sample extraction, and better preserve the natural state of the rock. Sampling the core using the three-dimensional nine-point method can effectively capture information related to fracture development. The sample taken by oblique sampling may include microfracture data from multiple directions, which can more accurately reflect the mechanical characteristics of the rock mass. The oblique sampling angle in space can increase the diversity and representativeness of samples. This type of sampling can cover a wider range of structural characteristics, providing a more comprehensive data foundation for subsequent analysis. In addition, the three-dimensional nine-point sampling method can balance the stress distribution in different directions to a certain extent, making the experimental data acquired truly reflect the mechanical properties of rocks.

The characteristic core sampling and parameter arrangement of the tight sandstone reservoir by the multi-level three-dimensional nine-point method specifically includes five steps.

Firstly, nine potential study areas are selected in a study area using the three-dimensional nine-point method to maximize the representativeness of samples. The sampling areas should include some special geological structures or abnormal areas, which usually exhibit significant differences in mechanical properties. For example, sampling points near faults, folds, or other geological structures can be selected so as to provide a more comprehensive understanding of the geostress state and its impact on the reservoir's mechanical properties. This method can help identify potential mechanical weak zones and their impact on horizontal drilling in research.

Secondly, nine potential sampling points are selected within the sampling area using the three-dimensional nine-point method. When the sampling points are selected in the sampling area, the distribution of the points should reflect the heterogeneity of the entire reservoir. Considering that tight sandstone reservoirs typically have different lithofacies, particle types, and pore structures, sample points of different depths and geological units should be selected in the area so as to cover multiple types of rock characteristics. Preliminary screening is performed through geological profile analysis, existing drilling data, and geophysical logging data to ensure the wide and diverse range of samples.

Thirdly, the angle and distance in space are adjusted, and sampling points are increased or reduced according to the actual drilling situation. When specific sampling locations are selected, consideration should be given to the feasibility and safety of sampling techniques, as well as the current level of drilling and development in oil and gas fields. The selected location should be convenient for drilling and sample collection, while avoiding negative impacts on the environment and ecology.

Fourthly, if necessary, the number of samples is increased using the three-dimensional nine-point method based on the existing sampling points. If the study area is relatively small, the sampling points can be determined using the three-dimensional nine-point method at once.

Fifth, for the final acquired sample, basic characteristic data such as lithology, particle type, and particle size are acquired through laboratory testing. Meanwhile, detailed mechanical experiments are conducted to determine parameters such as elastic modulus, Poisson's ratio, brittleness, cohesion, fracture toughness, fracture pressure, internal friction angle, tensile strength, shear strength, maximum horizontal principal stress, minimum horizontal principal stress, vertical stress, and horizontal stress difference.

FIG. 5 shows sampling points acquired using the three-dimensional nine-point method in a case area of a tight sandstone reservoir. There are two stress singularities in the entire area, with an increase of 8 sampling points, one risk point, and one sampling point removed. Totally, there are 16 sampling points selected.

When sensitivity analysis is performed in rock mechanics, different lithofacies values can be set for experiments to observe the influence of lithofacies changes on rock strength and fracture propagation behavior. This method helps identify parameters that are sensitive to the rock mechanics performance of different lithofacies.

The sensitivity analysis on the geological lithofacies rock mechanics parameters based on numerical simulation specifically includes five steps.

Firstly, based on a logging curve, a static result of rock mechanics measured indoors is calibrated, a single-well rock mechanics curve is calculated, the dynamic rock mechanics of the core is acquired through wave velocity testing, a conversion relationship between dynamic and static parameters is constructed, and an interpretation result of rock mechanics logging is corrected.

Secondly, the continuous single-well lithofacies data are discretized, and the same type of lithofacies is represented using specific codes. For lithofacies with similar mechanical properties, codes of similar size are used.

Thirdly, correlation analysis is performed. Statistical methods (such as regression analysis) are used to examine the relationship between the lithofacies codes and rock mechanics parameters, and parameters with significant fluctuations in mechanical parameters under different lithofacies are identified.

Fourthly, sensitivity analysis is performed. Sensitivity analysis methods such as analysis of variance (ANOVA) or local sensitivity analysis are used to further reveal the degree of influence of changes in rock mechanics parameters in different lithofacies on overall behavior, and the responses of different lithofacies to different mechanical parameters are quantified.

Fifthly, sensitive parameters are selected. All rock mechanics parameters are ranked, and the top few parameters with significant variations under different lithofacies are selected for further analysis. Multiple comparisons of candidate parameters are performed using statistical methods such as paired t-tests to determine their significant differences in different lithofacies. An optimization model between lithofacies and rock mechanics parameters is constructed to accurately predict mechanical behaviors under different lithofacies.

The lithofacies numbers within the case area are as follows: silty lithofacies: 1; fine-grained lithofacies: 2; medium-grained lithofacies: 3; coarse-grained lithofacies: 4; mudstone facies: 5; and limestone facies: 6. By selecting the rock mechanics parameters, four most sensitive rock mechanics parameters are acquired: elastic modulus, Poisson's ratio, brittleness index, and horizontal stress difference. Table 1 shows a correlation heat map between lithofacies and rock mechanics of the tight sandstone reservoir in a production area.

TABLE 1
Correlation heat map between lithofacies and rock mechanics
of the tight sandstone reservoir in a production area

| | | Fine- | Medium- | Coarse- | |
|---|---|---|---|---|---|
| | Silty | grained | grained | grained | |
| | lithofacies | lithofacies | lithofacies | lithofacies | Mudstone [symbol] |
| [symbol] | 0.71 | 0.77 | 0.76 | 0.73 | 0.84 |
| [symbol] | 0.79 | 0.82 | 0.75 | 0.76 | 0.84 |
| [symbol] | 0.61 | 0.74 | 0.76 | 0.66 | 0.7 |
| [symbol] | 0.73 | 0.79 | 0.57 | 0.52 | 0.56 |
| [symbol] | 0.63 | 0.68 | 0.34 | 0.54 | 0.5 |
| [symbol] | 0.61 | 0.77 | 0.36 | 0.58 | 0.41 |
| [symbol] | 0.38 | 0.61 | 0.38 | 0.39 | 0.47 |
| [symbol] | 0.48 | 0.77 | 0.31 | 0.44 | 0.36 |
| [symbol] | 0.48 | 0.35 | 0.3 | 0.43 | 0.38 |
| [symbol] | 0.4 | 0.5 | 0.53 | 0.59 | 0.41 |
| [symbol] | 0.47 | 0.43 | 0.43 | 0.43 | 0.52 |
| [symbol] | 0.34 | 0.35 | 0.31 | 0.21 | 0.36 |
| [symbol] | 0.88 | 0.83 | 0.86 | 0.71 | 0.85 |

[symbol]

indicates data missing or illegible when filed

Through the brittle boundary division method, the relationship between elastic modulus and Poisson's ratio is visualized, and material properties are effectively partitioned through negative slope lines. The specific process includes 2 steps.

Firstly, a cross plot is constructed, appropriate sample materials are collected and selected, and the elastic modulus (E) and Poisson's ratio (ν) of each material are measured. The measured data points are plotted in an E-v coordinate system to form a scatter plot.

Secondly, boundary lines are drawn. Through a regression analysis or empirical law, a straight line with a linear function property is drawn, ν=kE+b, where k denotes a positive slope and b denotes a bias. The brittleness index can comprehensively consider the elastic modulus and Poisson's ratio of rocks, and is usually used to measure whether rocks are more prone to brittle fracture or plastic deformation when subjected to stress. An appropriate parameter is determined to effectively divide the sample data into a brittle zone (lower left zone) and a tough zone (upper right zone) through the straight line.

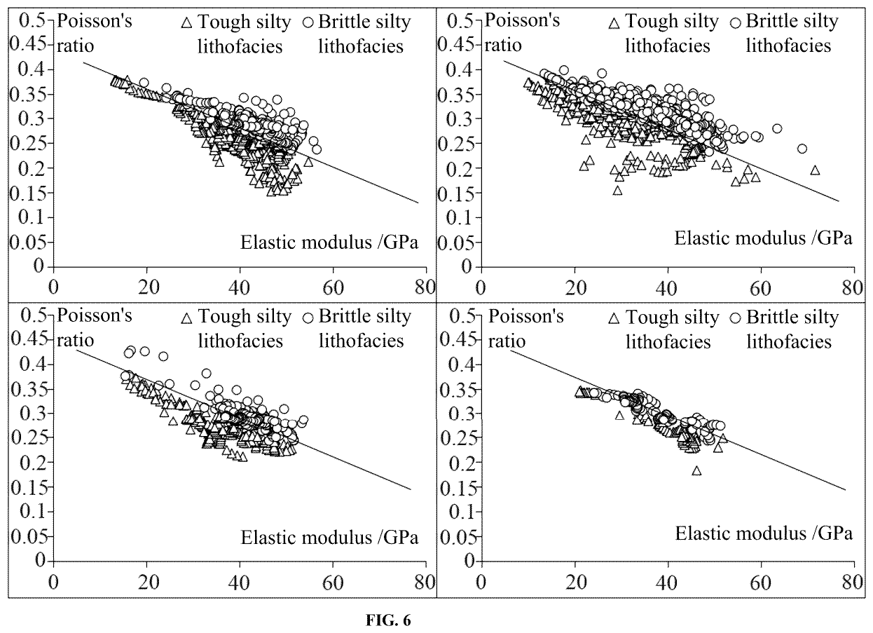

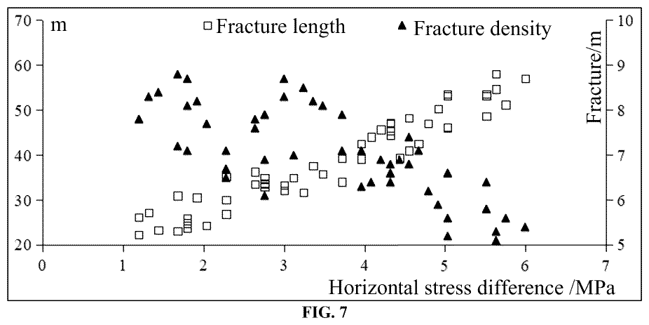

FIG. 6 shows a cross plot of elastic modulus and Poisson's ratio of the tight sandstone reservoir in the production area. According to statistics, when μ_{c}≥−3.695E_{c}×10⁻¹+0.425, a brittle lithofacies is presented, and when μ_{c}<−3.695E_{c}×10⁻³+0.425, a tough lithofacies is presented. Therefore, the brittleness index is used to evaluate the strain characteristics of lithofacies. A lithofacies with a high brittleness index leads to high content of brittle minerals and is more likely to form a fracture network with more stable fractures. Therefore, the open state of fractures can be maintained after pressure release, reducing the energy consumption and horizontal fracturing fluid volume during the fracturing process, and improving construction efficiency.

The horizontal stress difference in the tight sandstone reservoir has a significant impact on fracture propagation. In horizontal multi-stage fracturing operations, the magnitude of the horizontal stress difference will affect the formation, propagation, and connection of fractures, thereby affecting the effectiveness of oil and gas extraction. A larger stress difference can lead to more energy being concentrated at the fracture front. Due to the single fracture type, fractures can extend to greater depths within the rock. A smaller horizontal stress difference helps to control the direction of fracture propagation, increase the complexity of the fracture network, and reduce the risk of formation damage. The determination of the geological-mechanical coupled lithofacies geostress factor of the tight sandstone reservoir based on the stress optimization and identification model specifically includes two steps.

Firstly, a cross plot is constructed. The scatter data of fracture length and fracture density are respectively presented on the horizontal stress difference (x-axis) and fracture length/density (y-axis) plots, forming two types of scatter points. An intersection area is designed corresponding to the intersection of fracture length and fracture density, that is, a comprehensive area where fracture length decreases and fracture density increases.

Secondly, a public area is selected. An intersection area that is in a balanced position is selected. The left and right boundaries of the area are determined by the actual situation. The fracture length and fracture density reach their optimal state, which may correspond to the best fracturing effect of the formation and reduce the risk of formation damage. The corresponding horizontal stress difference in this area is the optimal horizontal stress difference, which can ensure the depth of fractures and increase the complexity of the fracture network to improve the fluidity and exchange of oil and gas.

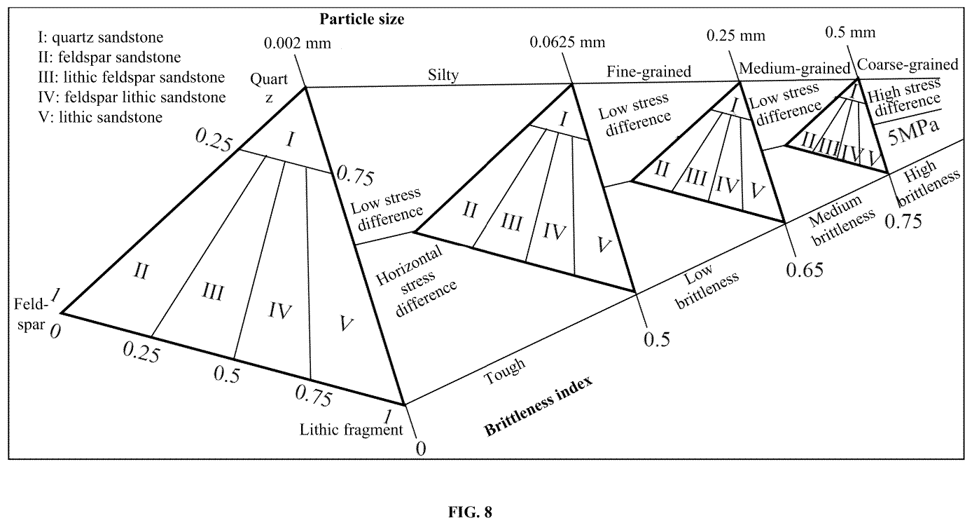

FIG. 7 shows a cross plot of fracture length and fracture density with horizontal stress difference in the tight sandstone reservoir in the certain production area. When the horizontal stress difference of the tight sandstone reservoir is less than 5 MPa, it usually has the geological conditions for volume fracturing, which can easily form a complex fracture network in remote wells.

Four elements of tight sandstone are selected: particle composition, particle size, brittleness index, and horizontal stress difference. They can represent the differences in geological conditions of the tight sandstone reservoir, reflect the degree of brittleness, stress differences, and the different effects of constructing fracture networks, thereby becoming the main controlling factors for the differences in tight gas potential of the tight sandstone reservoir in the production area.

Based on the above analysis and the differences in the four elements of tight sandstone: particle composition, particle size, brittleness index, and horizontal stress difference, the geological-mechanical coupled lithofacies classification mode of the tight sandstone reservoir is determined according to the following steps.

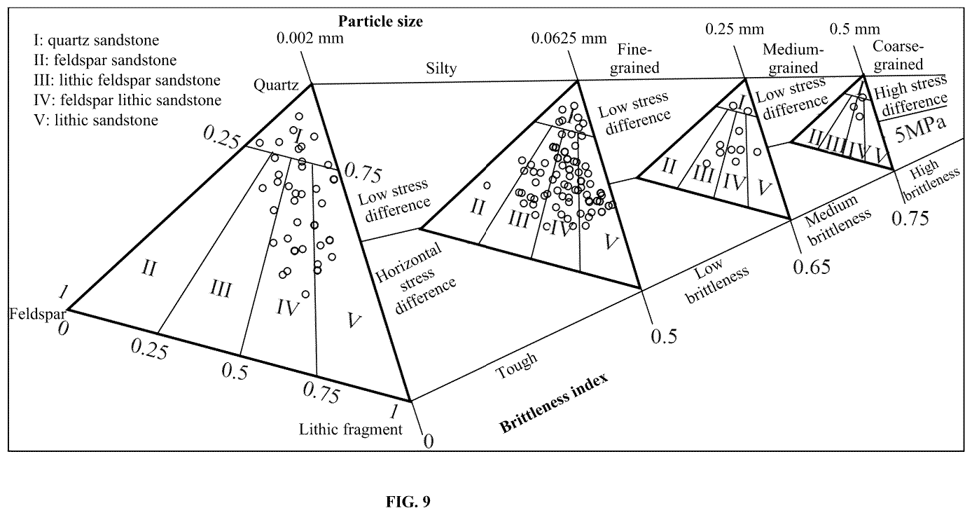

On the basis of the lithology classification isosceles-triangle chart of the tight sandstone reservoir, a composite triangle chart mode is further formed by integrating particle size, horizontal stress difference, and brittleness index. The particle size is divided into silt (0.002-0.0625 mm), fine grain (0.0625-0.25 mm), medium grain (0.25-0.5 mm), and coarse grain (greater than 0.5 mm). The brittleness index is divided into tough (0-0.5), low brittleness (0.5-0.65), medium brittleness (0.5-0.75), and high brittleness (greater than 0.75). The horizontal stress difference is divided into low stress difference (less than or equal to 5 MPa) and high stress difference (greater than 5 MPa). Based on the above classification methods, a composite isosceles-triangle chart mode for the classification of the geological-mechanical coupled lithofacies in the tight sandstone reservoir, as shown in FIG. 8.

The particle composition and particle size form the main part of the name, while the horizontal stress difference and brittleness index form the modificatory prefix, as shown in Table 2.

TABLE 2
Geological - mechanical coupled lithofacies classification
mode for the tight sandstone reservoir

| Mechanical modificatory prefix | | | |
|---|---|---|---|
| Horizontal stress | | Main part of geological name | |
| difference | Brittleness index | Particle composition | Particle size |
| Low-stress-difference | Tough sandstone | Quartz sandstone | Siltstone |
| sandstone | Low-brittleness | Feldspar sandstone | Fine sandstone |
| High-stress-difference | sandstone | Lithic feldspar | Medium sandstone |
| sandstone | Medium-brittleness | sandstone | Coarse sandstone |
| | sandstone | Feldspar lithic | |
| | High-brittleness | sandstone | |
| | sandstone | Lithic sandstone | |

The geological-mechanical coupled lithofacies types are named, and a geological-mechanical coupled lithofacies classification mode of the tight sandstone reservoir is ultimately constructed, as shown in Table 3.

FIG. 9 shows a classification result for the geological-mechanical coupled lithofacies of the tight sandstone reservoir in the production area. The tight sandstone reservoir in the production area is dominated by feldspar lithic sandstone, accounting for up to 78%, followed by lithic feldspar sandstone and lithic sandstone, accounting for 13% and 9%, respectively. The geological-mechanical coupled lithofacies in this formation are classified. The results indicate that the geological-mechanical coupled lithofacies with a relatively high proportion in the reservoir include: A: low-stress-difference and low-brittleness feldspar lithic fine sandstone, B: low-stress-difference and low-brittleness lithic fine sandstone, C: low-stress-difference and tough feldspar lithic fine sandstone, D: low-stress-difference and low-brittleness feldspar lithic medium sandstone, E: low-stress-difference and low-brittleness quartz fine sandstone, and F: low-stress-difference and tough feldspar lithic medium sandstone. The A, B, D, and E lithofacies all exhibit fine grains, low stress difference, and low brittleness, making them potential lithofacies for fracturing and transforming the tight sandstone reservoir in the production area.

TABLE 3
Classifications for the geological - mechanical coupled
lithofacies of the tight sandstone reservoir

| | Horizontal | | | |
|---|---|---|---|---|
| | stress | | | |
| Geological - mechanical | difference/ | Brittleness | Particle | Particle |
| coupled lithofacies | MPa | index | composition | size/mm |
| Low-stress-difference tough | σ [symbol] ≤ 5 | 0-0.5 | q > 0.75 | 0.002-0.0625 |
| quartz siltstone | | | | |
| Low-stress-difference tough | σ [symbol] ≤ 5 | 0-0.5 | 0 < q < 0.75 | 0.002-0.0625 |
| feldspar siltstone | | | and | |
| | | | 3r < f | |
| Low-stress-difference tough | σ [symbol] ≤ 5 | 0-0.5 | 0 < q < 0.75 | 0.002-0.0625 |
| lithic feldspar siltstone | | | and | |
| | | | r < f < 3r | |
| Low-stress-difference tough | σ [symbol] ≤ 5 | 0-0.5 | 0 < q < 0.75 | 0.002-0.0625 |
| feldspar lithic siltstone | | | and | |
| | | | f < r < 3f | |
| Low-stress-difference tough | σ [symbol] ≤ 5 | 0-0.5 | 0 < q < 0.75 | 0.002-0.0625 |
| lithic siltstone | | | and | |
| | | | 3f < r | |
| Low-stress-difference low- | σ [symbol] ≤ 5 | 0.5-0.65 | q > 0.75 | 0.0625-0.25 |
| brittleness quartz fine | | | | |
| sandstone | | | | |
| Low-stress-difference low- | σ [symbol] ≤ 5 | 0.5-0.65 | 0 < q < 0.75 | 0.0625-0.25 |
| brittleness feldspar fine | | | and | |
| sandstone | | | 3r < f | |
| Low-stress-difference low- | σ [symbol] ≤ 5 | 0.5-0.65 | 0 < q < 0.75 | 0.0625-0.25 |
| brittleness lithic feldspar | | | and | |
| fine sandstone | | | r < f < 3r | |
| Low-stress-difference low- | σ [symbol] ≤ 5 | 0.5-0.65 | 0 < q < 0.75 | 0.0625-0.25 |
| brittleness feldspar lithic | | | and | |
| fine sandstone | | | f < r < 3f | |
| Low-stress-difference low- | σ [symbol] ≤ 5 | 0.5-0.65 | 0 < q < 0.75 | 0.0625-0.25 |
| brittleness lithic fine | | | and | |
| sandstone | | | 3f < r | |
| Low-stress-difference | σ [symbol] ≤ 5 | 0.65-0.75 | q > 0.75 | 0.25-0.5 |
| medium-brittleness quartz | | | | |
| medium sandstone | | | | |
| Low-stress-difference | σ [symbol] ≤ 5 | 0.65-0.75 | 0 < q < 0.75 | 0.25-0.5 |
| medium-brittleness feldspar | | | and | |
| medium sandstone | | | 3r < f | |
| Low-stress-difference | σ [symbol] ≤ 5 | 0.65-0.75 | 0 < q < 0.75 | 0.25-0.5 |
| medium-brittleness lithic | | | and | |
| feldspar medium sandstone | | | r < f < 3r | |
| Low-stress-difference | σ [symbol] ≤ 5 | 0.65-0.75 | 0 < q < 0.75 | 0.25-0.5 |
| medium-brittleness feldspar | | | and | |
| lithic medium sandstone | | | f < r < 3f | |
| Low-stress medium-low- | σ [symbol] ≤ 5 | 0.65-0.75 | 0 < q < 0.75 | 0.25-0.5 |
| brittleness lithic medium | | | and | |
| sandstone | | | 3f < r | |

Based on Chinese patent application 202011393013.1 “Intelligent Identification and Visualization Method for Lithofacies of Terrestrial Tight Reservoir”, the single-well identification result of the geological lithofacies in the tight sandstone reservoir is acquired. Then, considering the differences in the four elements of particle composition, particle size, brittleness index, and horizontal stress difference, based on the already formed geological-mechanical coupled lithofacies classification mode of the tight sandstone reservoir, further classification of the geological-mechanical coupled lithofacies is performed at a single-well level.

The geological-mechanical coupled lithofacies prediction method usually has two or more results. The multi-type lithofacies prediction results are integrated through three steps: numerical mapping, priority selection, and classification processing.

Firstly, numerical mapping: two columns of lithofacies numerical codes are merged into a new column, and the merging is performed by a summing-up method.

Secondly, priority selection: one column is selected based on priority from two columns of prediction results under different conditions. For example, lithofacies 1 is selected preferentially. If the value is 0, then lithofacies 2 is selected.

Thirdly, multi-type classification processing: If multi-type classification processing is required after merging, a new column can be created and assigned through conditional judgment.

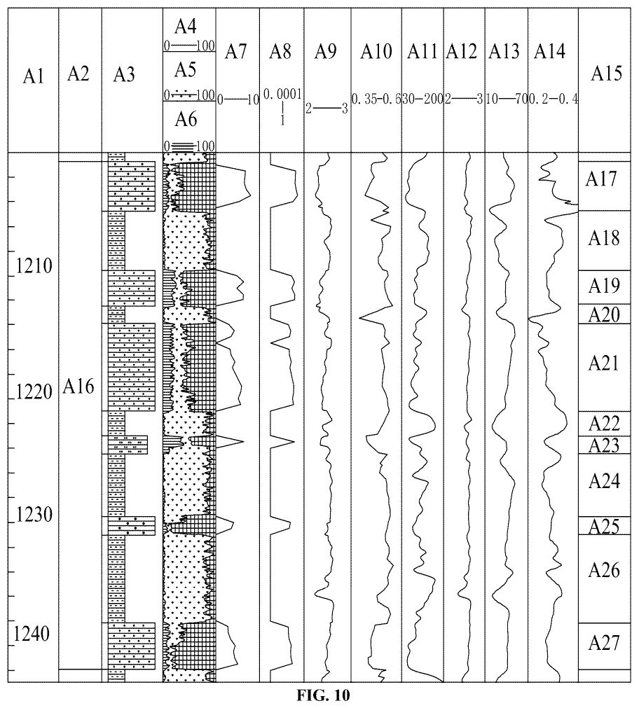

By the above method, the single-well facies control quantitative prediction of the geological-mechanical coupled lithofacies is completed in the case area. Based on the prediction result, a comprehensive column chart of the quantitative identification result of the geological-mechanical coupled lithofacies for a well in the tight sandstone in the production area is drawn, as shown in FIG. 10.

The characteristic extraction and visualization of the geological-mechanical coupled lithofacies in the three-dimensional mesh model is performed as follows.

Firstly, data acquisition and preparation are performed. Geological, seismic, and mechanical attribute data are acquired, including geological profiles, lithological data, seismic wave velocity, porosity, permeability, etc. Data preprocessing is performed, including interpolation, denoising, and normalization, to ensure data accuracy and integrity.

Secondly, a three-dimensional mesh model is constructed. Based on the spatial distribution and characteristics of the geological body, a three-dimensional mesh model is constructed. Finite element mesh or other types of mesh models can be used. Different geological units in the mesh model are subdivided to better express the geological-mechanical characteristics.

Thirdly, characteristic extraction is performed on the geological-mechanical coupled lithofacies. Based on geological data, the geological characteristics of each type of lithofacies (such as physical properties and elastic modulus) are extracted and assigned to the corresponding cells in the three-dimensional model.

Fourthly, sensitive attributes of the geological-mechanical coupled lithofacies are analyzed. Considering the influence of geological attributes (such as stress field and fracture distribution) on seismic wave propagation, sensitive attributes are selected, so as to determine the types of seismic sensitive attributes, typically including the following categories:
elastic wave velocity (P-wave velocity, S-wave velocity): closely related to the elastic characteristics of lithofacies;
impedance: calculated by multiplying density and wave velocity, and used to reflect the physical state of rocks;
amplitude: used to reflect the characteristics of reflection interfaces and changes in material properties during the propagation of seismic waves; and
frequency characteristics: used to reflect the details of rock layers as different lithofacies have different responses to seismic wave frequencies.

Fifthly, seismic data are processed and visualized. Seismic waveform data are processed, and inversion is performed to acquire information such as seismic wave velocity and impedance. The relationship between seismic data and the geological-mechanical model is visualized in a three-dimensional model, forming a seismic three-dimensional carving effect for the geological-mechanical coupled lithofacies.

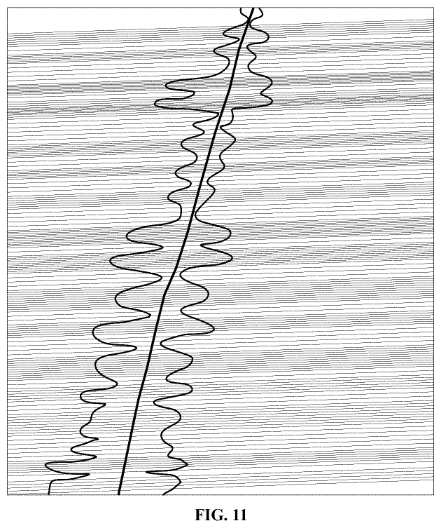

FIG. 11 shows an inversion profile of a longitudinal wave impedance of the geological-mechanical coupled lithofacies in the tight sandstone reservoir in the production area based on characteristic extraction and visualization of the geological-mechanical coupled lithofacies in a three-dimensional mesh model.

The feedback adjustment and seismic attribute mapping of lithofacies classification based on three-dimensional modeling is performed as follows.

Well data, seismic inversion results, and lithofacies information are integrated through geological modeling software such as Petrel.

Firstly, three-dimensional modeling is performed. A three-dimensional framework is constructed based on known geological characteristics such as structures and faults. By interpolation, Kriging method, etc., the distribution modeling of single-well distribution and seismic carving results of different lithofacies is performed in a three-dimensional space. The predicted lithofacies distribution of the model is compared with the actual downhole sampling results and the errors are analyzed. The deviation between model predictions and actual values is visually presented through three-dimensional visualization software, facilitating analysis and adjustment.

Secondly, feedback adjustment is performed. Based on the model validation results, the lithofacies classification criteria are adjusted (such as adding new classification parameters), or the parameter settings in the inversion algorithm are optimized. More training samples can be added or parameters can be readjusted to improve the accuracy of the model. Through continuous verification and correction, the optimal model is achieved. It is necessary to record the data input and output of each step for easy tracking and improvement.

Thirdly, result analysis is performed. The distribution characteristics of different lithofacies in the three-dimensional space are displayed, and colors or shadows are used to represent different lithofacies types.

Fourthly, seismic attribute mapping is performed. Seismic attributes (such as velocity and impedance) are displayed by combining color mapping with lithofacies information, and their correlation is analyzed. Analytic hierarchy process (AHP) is performed to define key levels in the model, identify major geological units and characteristics, and help understand geological evolution and tectonic environments.

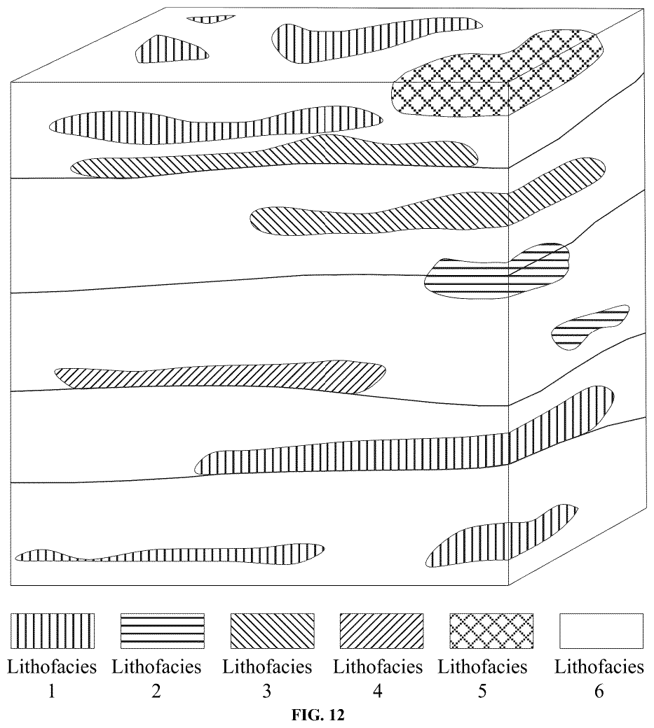

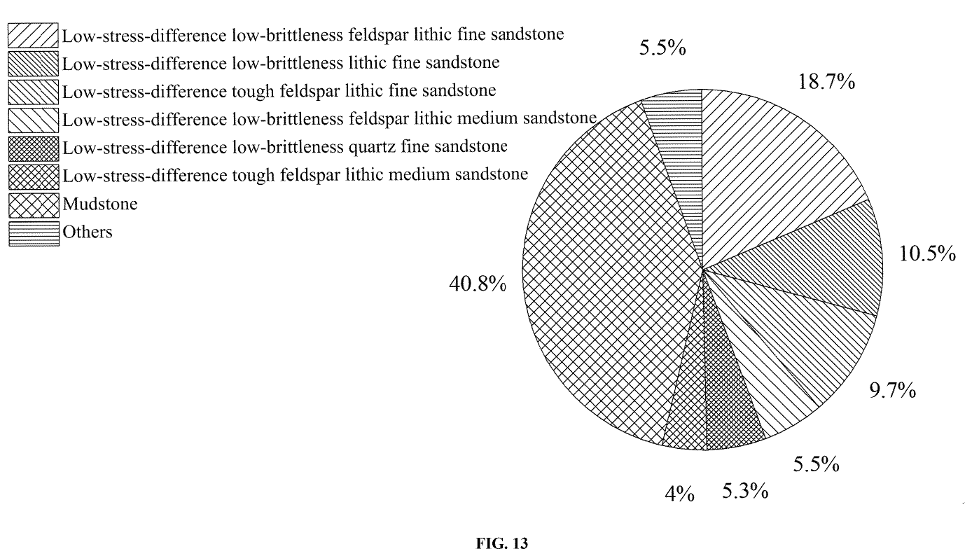

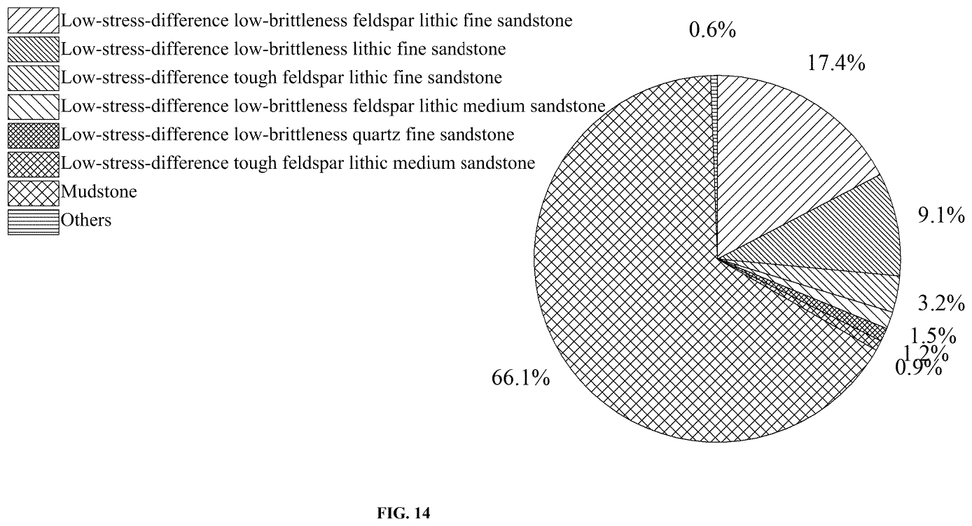

FIG. 12 shows a three-dimensional model of a typical tight sandstone geological-mechanical coupled lithofacies in the tight sandstone reservoir in the production area after feedback adjustment and seismic attribute mapping of lithofacies classification based on three-dimensional modeling. There are six types of lithofacies with a relatively large volume proportion among the accumulation lithofacies in the three-dimensional space of the statistical analysis area, including A: low-stress-difference and low-brittleness feldspar lithic fine sandstone, B: low-stress-difference and low-brittleness feldspar lithic fine sandstone, C: low-stress-difference tough feldspar lithic fine sandstone, D: low-stress-difference and low-brittleness feldspar lithic medium sandstone, E: low-stress-difference and low-brittleness quartz fine sandstone, and F: low-stress-difference tough feldspar lithic medium sandstone. Among them, the typical main accumulation lithofacies is low-stress-difference and low-brittleness feldspar lithic fine sandstone (FIGS. 13 and 14). This type of lithofacies has good porosity and permeability, providing a foundation for fluid storage and flow. The lithofacies has a lower stress difference, which makes it less likely for the rock to be damaged during hydraulic fracturing and other operations, thereby better maintaining structural integrity and reducing unnecessary fracture closure. The low-brittleness characteristic enables rocks to form an effective fracture network during transformation, which can better withstand internal pressure and maintain the flow capacity of fractures. The relationship between the tight gas production capacity and geological-mechanical coupled lithofacies of the typical tight sandstone in the production area is statistically analyzed (FIG. 15). The results show that the corresponding productivity of the four geological-mechanical coupled lithofacies: B, D, E, and F, is much higher than that of other lithofacies types. According to their geological and engineering factors, the B, D, E, and F lithofacies feature suitable particle size and composition, as well as reasonable stress difference and brittleness level, which jointly promote higher productivity. These four lithofacies can efficiently unleash their development potential under typical geological environments and technical conditions in the production area.

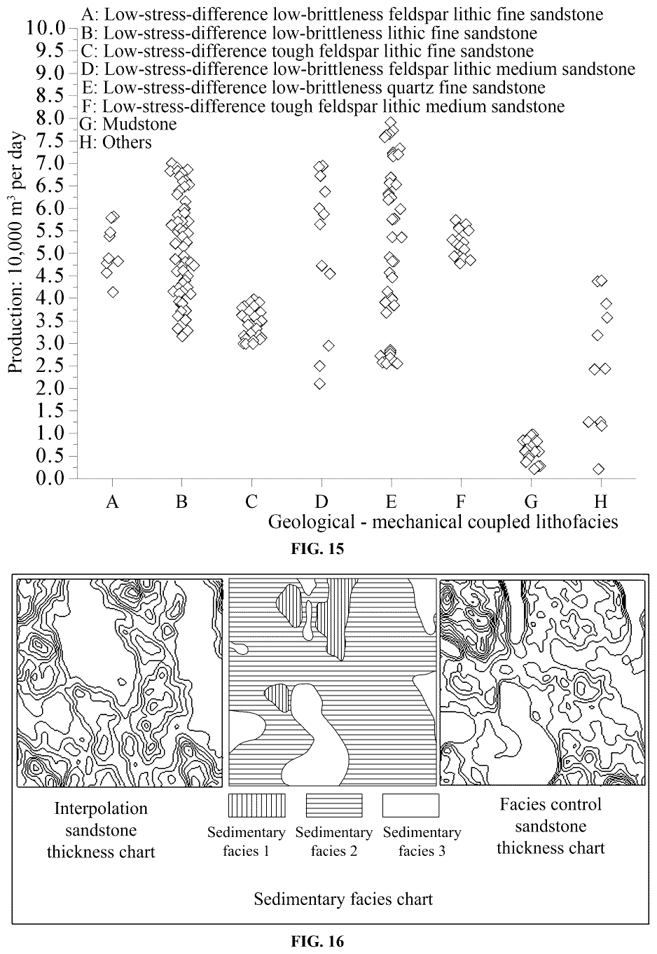

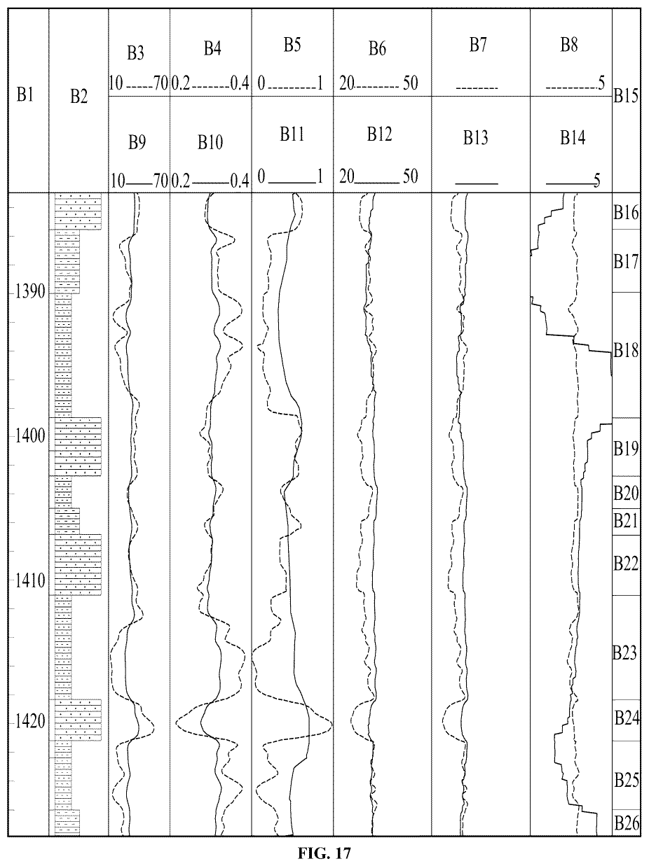

In the typical tight sandstone reservoir in the production area, a rock mechanics parameter model is constructed based on the constructed geological-mechanical coupled lithofacies model. The three-dimensional model of brittleness index before and after geological-mechanical coupled lithofacies control is extracted (FIG. 16). The results show that the brittleness index distribution model after facies control better reflects the heterogeneity of sedimentary facies in both longitudinal and transverse characteristics, which is superior to traditional Kriging or Gaussian interpolation three-dimensional models. By projecting a facies control three-dimensional model of rock mechanics parameters and an interpolation three-dimensional model (FIG. 17) into a control well, it is found that parameters such as elastic modulus, Poisson's ratio, brittleness index, maximum and minimum horizontal principal stresses, and horizontal stress difference all exhibit distribution laws consistent with the model. That is, the rock mechanics parameters after facies control all conform to the parameter range in the geological-mechanical coupled lithofacies classification model table (Table 3) of the tight sandstone reservoir. This accurately characterizes the heterogeneous distribution law of the rock mechanics and geostress characteristics of the tight sandstone reservoir in the production area, providing technical support for the effective implementation of ultra-long horizontal wells+large-scale refracturing for tight sandstone oil and gas in the area, and ultimately improving the production efficiency of tight sandstone oil and gas.

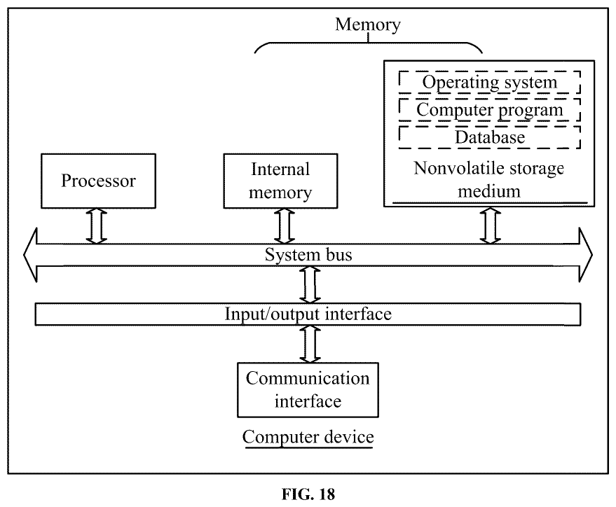

An exemplary embodiment provides a computer device. The computer device may be a server or terminal, and its internal structure may be that shown in FIG. 18. The computer device includes a processor, a memory, an input/output (I/O) interface, and a communication interface. The processor, the memory, and the I/O interface are connected through a system bus. The communication interface is connected to the system bus through the I/O interface. The processor of the computer device is configured to provide computing and control capabilities. The memory of the computer device includes a non-volatile storage medium and an internal memory. The nonvolatile storage medium is configured to store an operating system, a computer program, and a database. The internal memory provides an environment for operation of the operating system and the computer program in the nonvolatile storage medium. The I/O interface of the computer device is configured to exchange information between the processor and an external apparatus. The communication interface of the computer device is configured to communicate with an external terminal through a network. The computer program is executed by the processor to implement a well-seismic analysis method based on a tight sandstone geological-mechanical coupled lithofacies system.

What is claimed is:

1. A well-seismic analysis system based on a tight sandstone geological-mechanical coupled lithofacies system, comprising:
an information data acquisition module acquires information data, comprising characteristic core data and rock mechanics data, wherein the characteristic core data comprises characteristic data acquired through a three-dimensional nine-point method and parameter data determined based on a mechanical experiment, and the rock mechanics data is parameter data that is sensitive to rock mechanics performance of different lithofacies and is acquired by setting different lithofacies numerical experiments based on a theory of lithofacies discretization and sensitivity analysis to study an influence of a lithofacies change on a rock strength and a fracture propagation behavior;
a classification mode construction module connected to the information data acquisition module constructs a geological-mechanical coupled lithofacies classification mode for a tight sandstone reservoir based on the information data through a four-element composite triangle chart method;
an integration module connected to the classification mode construction module classifies, by the geological-mechanical coupled lithofacies classification mode of the tight sandstone reservoir, geological-mechanical coupled lithofacies at a single-well level based on element difference data, and integrate multi-type lithofacies prediction results to acquire an integration result, wherein the element difference data comprises particle composition, particle size, brittleness index, and horizontal stress difference; and
an analysis and determination module connected to the integration module performs, by a well-seismic collaborative three-dimensional model of the geological-mechanical coupled lithofacies in the tight sandstone reservoir, characteristic extraction of the geological-mechanical coupled lithofacies, lithofacies classification feedback adjustment, and seismic attribute mapping based on the integration result, and determines geological-mechanical coupled lithofacies distribution information data of the tight sandstone reservoir, wherein the well-seismic collaborative three-dimensional model of the geological-mechanical coupled lithofacies in the tight sandstone reservoir is a physical model constructed based on seismic data and a geological-mechanical characteristic relationship, and the geological-mechanical coupled lithofacies distribution information data of the tight sandstone reservoir is configured to characterize a heterogeneous distribution law of a rock mechanics and geostress characteristic of the tight sandstone reservoir, providing a basis for improving an effect of tight sandstone oil and gas extraction.

2. The well-seismic analysis system based on a tight sandstone geological-mechanical coupled lithofacies system according to claim 1, wherein the classification mode construction module comprises:
a brittleness factor determination sub-module connected to the information data acquisition module to visualize a relationship between an elastic modulus and a Poisson's ratio based on information data through a brittle boundary division method and divide a material property by a negative slope line to determine a brittleness factor for the geological-mechanical coupled lithofacies in the tight sandstone reservoir;
a geostress factor determination sub-module connected to the information data acquisition module determines, by a stress optimization and identification model, a geostress factor for the geological-mechanical coupled lithofacies in the tight sandstone reservoir based on the information data, wherein the stress optimization and identification model is a physical model about an influence of a horizontal stress difference on fracture propagation in the tight sandstone reservoir and is constructed based on the horizontal stress difference that influences fracture formation, propagation, and connection in a horizontal multi-stage fracturing operation;
a chart determination sub-module connected to the brittleness factor determination sub-module and the geostress factor determination sub-module separately, integrates, by a lithology classification isosceles-triangle chart of the tight sandstone reservoir, the particle size, horizontal stress difference, and brittleness index for composite triangle chart mode processing based on the brittleness factor and the geostress factor of the geological-mechanical coupled lithofacies in the tight sandstone reservoir, thereby acquiring a composite isosceles-triangle chart for the classification of the geological-mechanical coupled lithofacies in the tight sandstone reservoir; and
a classification mode construction sub-module connected to the chart determination sub-module names, by the composite isosceles-triangle chart for the classification of the geological-mechanical coupled lithofacies in the tight sandstone reservoir, types of the geological-mechanical coupled lithofacies by taking the particle composition and particle size as a name part and the horizontal stress difference and brittleness index as a modificatory prefix, thereby determining the geological-mechanical coupled lithofacies classification mode of the tight sandstone reservoir.

3. The well-seismic analysis system based on a tight sandstone geological-mechanical coupled lithofacies system according to claim 1, wherein the integration module comprises:
a single-well identification result acquisition sub-module acquires a single-well identification result of a geological lithofacies in the tight sandstone reservoir;
a classification sub-module connected to the single-well identification result acquisition sub-module and the classification mode construction module separately, classifies, based on the geological-mechanical coupled lithofacies classification mode of the tight sandstone reservoir and the single-well identification result of the geological lithofacies in the tight sandstone reservoir, the geological-mechanical coupled lithofacies at the single-well level according to the element difference data, and acquire a classification result; and
an integration processing sub-module connected to the classification sub-module performs numerical mapping, priority selection, and classification processing based on the classification result and integrate multi-type lithofacies prediction results to acquire the integration result.

4. A well-seismic analysis method based on a tight sandstone geological-mechanical coupled lithofacies system, implemented by the system according to claim 1, and comprising:
acquiring information data, comprising characteristic core data and rock mechanics data, wherein the characteristic core data comprises characteristic data acquired through a three-dimensional nine-point method and parameter data determined based on a mechanical experiment; and the rock mechanics data is parameter data that is sensitive to rock mechanics performance of different lithofacies and is acquired by setting different lithofacies numerical experiments based on a theory of lithofacies discretization and sensitivity analysis to study an influence of a lithofacies change on a rock strength and a fracture propagation behavior;
constructing a geological-mechanical coupled lithofacies classification mode for a tight sandstone reservoir based on the information data through a four-element composite triangle chart method;
classifying, by the geological-mechanical coupled lithofacies classification mode of the tight sandstone reservoir, geological-mechanical coupled lithofacies at a single-well level based on element difference data, and integrating multi-type lithofacies prediction results to acquire an integration result, wherein the element difference data comprises particle composition, particle size, brittleness index, and horizontal stress difference; and
performing, by a well-seismic collaborative three-dimensional model of the geological-mechanical coupled lithofacies in the tight sandstone reservoir, characteristic extraction of the geological-mechanical coupled lithofacies, lithofacies classification feedback adjustment, and seismic attribute mapping based on the integration result, and determining geological-mechanical coupled lithofacies distribution information data of the tight sandstone reservoir, wherein the well-seismic collaborative three-dimensional model of the geological-mechanical coupled lithofacies in the tight sandstone reservoir is a physical model constructed based on seismic data and a geological-mechanical characteristic relationship, and the geological-mechanical coupled lithofacies distribution information data of the tight sandstone reservoir is configured to characterize a heterogeneous distribution law of a rock mechanics and geostress characteristic of the tight sandstone reservoir, providing a basis for improving an effect of tight sandstone oil and gas extraction.

5. The well-seismic analysis method based on a tight sandstone geological-mechanical coupled lithofacies system according to claim 4, wherein the constructing a geological-mechanical coupled lithofacies classification mode for a tight sandstone reservoir based on the information data through a four-element composite triangle chart method comprises:
visualizing a relationship between an elastic modulus and a Poisson's ratio based on information data through a brittle boundary division method, and dividing a material property by a negative slope line to determine a brittleness factor for the geological-mechanical coupled lithofacies in the tight sandstone reservoir;
determining, by a stress optimization and identification model, a geostress factor for the geological-mechanical coupled lithofacies in the tight sandstone reservoir based on the information data, wherein the stress optimization and identification model is a physical model about an influence of a horizontal stress difference on fracture propagation in the tight sandstone reservoir and is constructed based on the horizontal stress difference that influences fracture formation, propagation, and connection in a horizontal multi-stage fracturing operation;
integrating, by a lithology classification isosceles-triangle chart of the tight sandstone reservoir, the particle size, horizontal stress difference, and brittleness index for composite triangle chart mode processing based on the brittleness factor and the geostress factor of the geological-mechanical coupled lithofacies in the tight sandstone reservoir, thereby acquiring a composite isosceles-triangle chart for the classification of the geological-mechanical coupled lithofacies in the tight sandstone reservoir; and
naming, by the composite isosceles-triangle chart for the classification of the geological-mechanical coupled lithofacies in the tight sandstone reservoir, types of the geological-mechanical coupled lithofacies by taking the particle composition and particle size as a name part and the horizontal stress difference and brittleness index as a modificatory prefix, thereby determining the geological-mechanical coupled lithofacies classification mode of the tight sandstone reservoir.

6. The well-seismic analysis method based on a tight sandstone geological-mechanical coupled lithofacies system according to claim 4, wherein the classifying, by the geological-mechanical coupled lithofacies classification mode of the tight sandstone reservoir, geological-mechanical coupled lithofacies at a single-well level based on element difference data, and integrating multi-type lithofacies prediction results to acquire an integration result comprises:
acquiring a single-well identification result of a geological lithofacies in the tight sandstone reservoir;
classifying, based on the geological-mechanical coupled lithofacies classification mode of the tight sandstone reservoir and the single-well identification result of the geological lithofacies in the tight sandstone reservoir, the geological-mechanical coupled lithofacies at the single-well level according to the element difference data, and acquiring a classification result; and
performing numerical mapping, priority selection, and classification processing based on the classification result, and integrating multi-type lithofacies prediction results to acquire the integration result.

7. The well-seismic analysis method based on a tight sandstone geological-mechanical coupled lithofacies system according to claim 4, wherein the well-seismic collaborative three-dimensional model of the geological-mechanical coupled lithofacies in the tight sandstone reservoir is determined by:
acquiring raw data comprising geological, seismic, and mechanical properties; and the raw data comprises geological profile, lithological data, seismic wave velocity, porosity, and permeability;
preprocessing the raw data to acquire processed data, wherein the preprocessing comprises interpolation, denoising, and normalization;
constructing a three-dimensional mesh model, wherein the three-dimensional network model is a physical model constructed based on a spatial distribution and characteristic of a geological body to characterize a geological-mechanical characteristic relationship;
performing characteristic extraction on the geological-mechanical coupled lithofacies based on the processed data to acquire extracted data;
performing sensitive attribute analysis on the geological-mechanical coupled lithofacies based on geological attribute data and the extracted data to acquire analyzed data;
performing, by the three-dimensional mesh model, inversion based on the analyzed data, and determining inversion information data, comprising seismic wave velocity and impedance;
comparing the inversion information data with an actual underground sampling result, and training and adjusting an inversion parameter of the three-dimensional mesh model with a goal of minimizing an error of a comparison result, thereby acquiring an adjusted three-dimensional mesh model; and
determining the adjusted three-dimensional mesh model as the well-seismic collaborative three-dimensional model of the geological-mechanical coupled lithofacies in the tight sandstone reservoir.

8. The well-seismic analysis method based on a tight sandstone geological-mechanical coupled lithofacies system according to claim 4, wherein the characteristic data comprises lithology, particle type, and particle size.

9. The well-seismic analysis method based on a tight sandstone geological-mechanical coupled lithofacies system according to claim 4, wherein the parameter data comprises: elastic modulus, Poisson's ratio, brittleness, cohesion, fracture toughness, fracture pressure, internal friction angle, tensile strength, shear strength, maximum horizontal principal stress, minimum horizontal principal stress, vertical stress, and horizontal stress difference.

10. A computer device, comprising a memory, a processor, and a computer program stored in the memory and executable in the processor, wherein the computer program is executed by the processor to implement the well-seismic analysis method based on a tight sandstone geological-mechanical coupled lithofacies system according to claim 4.

11. The well-seismic analysis method based on a tight sandstone geological-mechanical coupled lithofacies system according to claim 4, wherein the classification mode construction module comprises:
a brittleness factor determination sub-module connected to the information data acquisition module, visualizes a relationship between an elastic modulus and a Poisson's ratio based on information data through a brittle boundary division method and divides a material property by a negative slope line to determine a brittleness factor for the geological-mechanical coupled lithofacies in the tight sandstone reservoir;
a geostress factor determination sub-module connected to the information data acquisition module determines, by a stress optimization and identification model, a geostress factor for the geological-mechanical coupled lithofacies in the tight sandstone reservoir based on the information data, wherein the stress optimization and identification model is a physical model about an influence of a horizontal stress difference on fracture propagation in the tight sandstone reservoir and is constructed based on the horizontal stress difference that influences fracture formation, propagation, and connection in a horizontal multi-stage fracturing operation;
a chart determination sub-module connected to the brittleness factor determination sub-module and the geostress factor determination sub-module separately, integrates, by a lithology classification isosceles-triangle chart of the tight sandstone reservoir, the particle size, horizontal stress difference, and brittleness index for composite triangle chart mode processing based on the brittleness factor and the geostress factor of the geological-mechanical coupled lithofacies in the tight sandstone reservoir, thereby acquiring a composite isosceles-triangle chart for the classification of the geological-mechanical coupled lithofacies in the tight sandstone reservoir; and
a classification mode construction sub-module connected to the chart determination sub-module names, by the composite isosceles-triangle chart for the classification of the geological-mechanical coupled lithofacies in the tight sandstone reservoir, types of the geological-mechanical coupled lithofacies by taking the particle composition and particle size as a name part and the horizontal stress difference and brittleness index as a modificatory prefix, thereby determining the geological-mechanical coupled lithofacies classification mode of the tight sandstone reservoir.

12. The well-seismic analysis method based on a tight sandstone geological-mechanical coupled lithofacies system according to claim 4, wherein the integration module comprises:
a single-well identification result acquisition sub-module acquires a single-well identification result of a geological lithofacies in the tight sandstone reservoir;
a classification sub-module connected to the single-well identification result acquisition sub-module and the classification mode construction module separately, classifies, based on the geological-mechanical coupled lithofacies classification mode of the tight sandstone reservoir and the single-well identification result of the geological lithofacies in the tight sandstone reservoir, the geological-mechanical coupled lithofacies at the single-well level according to the element difference data, and acquire a classification result; and
an integration processing sub-module connected to the classification sub-module performs numerical mapping, priority selection, and classification processing based on the classification result and integrate multi-type lithofacies prediction results to acquire the integration result.

13. The computer device according to claim 10, wherein the constructing a geological-mechanical coupled lithofacies classification mode for a tight sandstone reservoir based on the information data through a four-element composite triangle chart method specifically comprises:
visualizing a relationship between an elastic modulus and a Poisson's ratio based on information data through a brittle boundary division method, and dividing a material property by a negative slope line to determine a brittleness factor for the geological-mechanical coupled lithofacies in the tight sandstone reservoir;
determining, by a stress optimization and identification model, a geostress factor for the geological-mechanical coupled lithofacies in the tight sandstone reservoir based on the information data, wherein the stress optimization and identification model is a physical model about an influence of a horizontal stress difference on fracture propagation in the tight sandstone reservoir and is constructed based on the horizontal stress difference that influences fracture formation, propagation, and connection in a horizontal multi-stage fracturing operation;
integrating, by a lithology classification isosceles-triangle chart of the tight sandstone reservoir, the particle size, horizontal stress difference, and brittleness index for composite triangle chart mode processing based on the brittleness factor and the geostress factor of the geological-mechanical coupled lithofacies in the tight sandstone reservoir, thereby acquiring a composite isosceles-triangle chart for the classification of the geological-mechanical coupled lithofacies in the tight sandstone reservoir; and
naming, by the composite isosceles-triangle chart for the classification of the geological-mechanical coupled lithofacies in the tight sandstone reservoir, types of the geological-mechanical coupled lithofacies by taking the particle composition and particle size as a name part and the horizontal stress difference and brittleness index as a modificatory prefix, thereby determining the geological-mechanical coupled lithofacies classification mode of the tight sandstone reservoir.

14. The computer device according to claim 10, wherein the classifying, by the geological-mechanical coupled lithofacies classification mode of the tight sandstone reservoir, geological-mechanical coupled lithofacies at a single-well level based on element difference data, and integrating multi-type lithofacies prediction results to acquire an integration result specifically comprises:
acquiring a single-well identification result of a geological lithofacies in the tight sandstone reservoir;
classifying, based on the geological-mechanical coupled lithofacies classification mode of the tight sandstone reservoir and the single-well identification result of the geological lithofacies in the tight sandstone reservoir, the geological-mechanical coupled lithofacies at the single-well level according to the element difference data, and acquiring a classification result; and
performing numerical mapping, priority selection, and classification processing based on the classification result, and integrating multi-type lithofacies prediction results to acquire the integration result.

15. The computer device according to claim 10, wherein the well-seismic collaborative three-dimensional model of the geological-mechanical coupled lithofacies in the tight sandstone reservoir is determined by:
acquiring raw data, wherein the raw data are data comprising geological, seismic, and mechanical properties; and the raw data comprises geological profile, lithological data, seismic wave velocity, porosity, and permeability;
preprocessing the raw data to acquire processed data, the preprocessing comprises interpolation, denoising, and normalization;
constructing a three-dimensional mesh model that is a physical model constructed based on a spatial distribution and characteristic of a geological body to characterize a geological-mechanical characteristic relationship;
performing characteristic extraction on the geological-mechanical coupled lithofacies based on the processed data to acquire extracted data;
performing sensitive attribute analysis on the geological-mechanical coupled lithofacies based on geological attribute data and the extracted data to acquire analyzed data;
performing, by the three-dimensional mesh model, inversion based on the analyzed data, and determining inversion information data, comprising seismic wave velocity and impedance;
comparing the inversion information data with an actual underground sampling result, and training and adjusting an inversion parameter of the three-dimensional mesh model with a goal of minimizing an error of a comparison result, thereby acquiring an adjusted three-dimensional mesh model; and
determining the adjusted three-dimensional mesh model as the well-seismic collaborative three-dimensional model of the geological-mechanical coupled lithofacies in the tight sandstone reservoir.

16. The computer device according to claim 10, wherein the characteristic data comprises lithology, particle type, and particle size.

17. The computer device according to claim 10, wherein the parameter data comprises: elastic modulus, Poisson's ratio, brittleness, cohesion, fracture toughness, fracture pressure, internal friction angle, tensile strength, shear strength, maximum horizontal principal stress, minimum horizontal principal stress, vertical stress, and horizontal stress difference.
